(19) United States
(12) Patent Application Publication
(10) Pub. No.: US 2019/0386293 A1
(43) Pub. Date: Dec. 19, 2019

(54) TERNARY MATERIAL AND PREPARATION METHOD THEREOF, BATTERY SLURRY, POSITIVE ELECTRODE AND LITHIUM BATTERY

(71) Applicant: BYD COMPANY LIMITED, SHENZHEN, GUANGDONG (CN)

(72) Inventors: Jinghua CHEN, Shenzhen (CN); Junfei YOU, Shenzhen (CN); Chaqing XU, Shenzhen (CN); Wenyu CAO, Shenzhen (CN)

(73) Assignee: BYD COMPANY LIMITED, SHENZHEN, GUANGDONG (CN)

(21) Appl. No.: 16/471,534

(22) PCT Filed: Dec. 1, 2017
(86) PCT No.: PCT/CN2017/114264

§ 371 Date: Jun. 19, 2019

(30) Foreign Application Priority Data
Dec. 20, 2016 (CN) 201611187632.9

(51) Int. Cl. H01M 4/36; H01M 10/0525; H01M 4/525; C01G 53/00

(52) U.S. Cl. CPC H01M 4/364; H01M 10/0525; H01M 2004/027; C01G 53/50; C01G 53/42; H01M 4/525

(57) ABSTRACT

The present specification discloses a ternary material and a preparation method thereof, a battery slurry, an anode and a lithium battery. The ternary material has a composition represented by the general formula LiNi_{1-x-y}CoₓM_{y}O₂, where the M is Mn or Al, 0<x<1, 0<y<1, x+y<1; and particles of the ternary material include three-level particles having a particle diameter ranging from small to large, the three-level particles include primary particles having a crystal structure, intermediate particles formed by partial melting of a plurality of primary particles, and secondary spheres formed by agglomeration of the intermediate particles.

### FIELD

The present specification relates to the field of lithium battery production, in particular to a ternary material and a preparation method thereof, a battery slurry, an anode and a lithium battery.

### BACKGROUND

Lithium-ion batteries have received extensive attention due to a series of significant advantages such as high operating voltage, large energy capacity, light weight, small size, long cycle life, no memory effect, fast charge and discharge, and no environmental pollution. Two major tasks of lithium-ion battery research are to improve performance (mainly high energy density and power density, long life, and safety) and to reduce cost. The anode material is the key to improving the performance of lithium-ion batteries, which determines the main performance indicators of lithium-ion batteries.

In recent years, the new layered lithium intercalated ternary material Li—Ni—Co—Mn—O composite oxide has developed rapidly, and a representative product is lithium nickel cobalt manganese oxide (LiNi_{1/3}Co_{1/3}Mn_{1/3}O₂). Such materials have stable electrochemical performance, high discharge capacity and discharge rate, good thermal stability, and good safety. Its comprehensive performance is superior to any single-component compound, and it is a new material to replace lithium cobaltate for an anode. The two of main existing preparation methods of the ternary materials include, a conventional high-temperature solid phase method, and a conventional hydrothermal method.

The conventional high-temperature solid phase method for preparing the ternary material is achieved by mixing and sintering a ternary material precursor and a lithium source. This method has the following problems. (1) After the material is sintered for a long time at a high temperature, primary particles are larger (generally exceeding 500 nm, and even reaching a micron level). The material of the large particles has a small specific surface area, and thus the high-temperature storage and high-temperature cycle performance of the material are acceptable, and the compaction density is high. But the low-temperature performance and high-current rate performance of the material are not sufficient to meet the high rate performance requirement of a power battery. (2) The ternary material is prepared by mixing and sintering the precursor and the lithium salt at a high temperature. The diffusion of the lithium element into the interior of the precursor secondary sphere at high temperature requires long-time high-temperature sintering, and it is necessary to add a lithium salt that exceeds the theoretical measurement value by nearly 10% to ensure sufficient distribution of lithium, which will increase the material cost. In addition, the excess lithium salt that is not sufficiently diffused into the interior of the secondary sphere will be distributed as free lithium on the surface of the secondary sphere, which will cause a high pH value and a large powder resistance of the material. This will eventually cause problems such as great thickness variation and great increase in internal resistance during high-temperature storage and cycle of a battery, which greatly reduces the safety of the battery.

The conventional hydrothermal method for preparing the ternary material (such as the disclosure of patent application CN201410184691.5) includes: adding an anode material precursor, a lithium compound, and water to an autoclave; then raising the temperature to a specified temperature T, keeping the temperature constant under supercritical hydrothermal conditions for a period of time H1, adding an oxidant by a booster pump under high temperature and high pressure, and keeping the temperature constant for a period of time H2; and cooling to room temperature, and after washing by pressure filtration, sending a final product to an atmosphere furnace for sintering. This method has the following problems. (1) When the ternary material is prepared by the traditional hydrothermal method, primary particles are small (generally within 300 nm), loosely dispersed, and are difficult to agglomerate into secondary spheres. The material has very large specific surface area, large contact area with electrolyte. The capacity, low-temperature performance, and rate performance are good, but the compaction density of the material is low, which is generally only 2.9 g/cm³ and far lower than that of the ternary material prepared by the solid phase method. Its energy density is about 20% lower than that of the ternary material prepared by the solid phase method, such that the high-temperature storage performance, high-temperature cycle performance, and normal temperature cycle performance are not sufficient to meet the usage requirements of the power battery. (2) According to the ternary material prepared by the traditional hydrothermal method, since the lithium content is low, generally lower than the theoretical metering ratio, lithium will be further lost in the later stage high-temperature sintering process. Lack of lithium in the material may eventually cause poor cycle performance and short battery life of the battery.

### SUMMARY

An objective of the present specification is to provide a ternary material and a preparation method thereof, a battery slurry, an anode and a lithium battery to balance the electrochemical performance of a lithium battery using the ternary material at low temperature, high temperature, and high rate.

To achieve the above objective, according to a first aspect of the present specification, a ternary material is provided, where the ternary material has a composition represented by a general formula LiNi_{1-x-y}CoₓM_{y}O₂, wherein the M is Mn or Al, 0<x<1, 0<y<1, x+y<1; and particles comprising three-level particles, each particle having a particle diameter range from small to large, wherein the three-level particles comprise primary particles having a crystal structure, intermediate particles formed by partial melting of the primary particles, and secondary spheres formed by agglomeration of the intermediate particles.

According to a second aspect of the present specification, a preparation method of a ternary material is provided. The preparation method comprising: preparing a mixed solution by dissolving a soluble nickel salt, a cobalt salt, an M salt, a first lithium source, and an oxidant system in a solvent, wherein the M is manganese or aluminum; promoting an oxidation reaction of the mixed solution, after the reaction, filtering, washing, and drying an oxidation reaction product to obtain a precursor powder, and mixing a second lithium source into the precursor powder to obtain a mixed powder; performing primary sintering on the mixed powder to obtain secondary spheres; and performing secondary sintering on the secondary spheres to obtain the ternary material; wherein, a temperature of the secondary sintering is higher than a temperature of the primary sintering.

According to a third aspect of the present specification, a ternary material prepared by the above preparation method according to the present specification is provided.

According to a fourth aspect of the present specification, a battery slurry is provided, wherein the battery slurry is a slurry composition with a solid content of 10-70 wt % and is prepared from the ternary material according to the present specification.

According to a fifth aspect of the present specification, an anode is provided, wherein the anode includes a current collector and an anode material layer disposed on the current collector, and the anode material layer includes the ternary material according to the present specification.

According to a sixth aspect of the present specification, a lithium battery is provided, wherein the lithium battery includes an anode, and the anode includes the anode according to the present specification.

Particles of the ternary material provided by the present specification include three-level particles having a particle diameter range from small to large. Specifically, primary particles (minimum constitutional unit) have a crystal structure, intermediate particles are formed by partial melting of a plurality of the primary particles, and secondary spheres are formed by agglomeration of the intermediate particles. The above technical solutions of the present specification have the following technical features.

(1) By forming the primary particles and utilizing the characteristic of smaller particle diameter of the primary particles, the ternary material has a short lithium ion deintercalation path, thereby optimizing the low-temperature performance and rate performance of the lithium battery using the ternary material.

(2) By forming the secondary spheres, the primary particles are agglomerated together to reduce the specific surface area and porosity of the ternary material under the same mass, to increase the compaction density of the ternary material, and to reduce thermal expansion and resistance change, thereby improving the safety of the lithium battery using the ternary material.

(3) By forming the intermediate particles, the loose primary particles agglomerated in the secondary spheres can be partially fused together to increase the compaction density and energy density of the ternary material, and to optimize the heat storage performance and thermal cycle performance of the lithium battery using the ternary material.

(4) By including three-level particles in the particles of the ternary material, the ternary material benefits from excellent low-temperature performance and rate performance of small particles and good high-temperature storage performance and high-temperature cycle performance of large particles.

Other features and advantages of the present specification will be described in detail in the following detailed description.

### BRIEF DESCRIPTION OF THE DRAWINGS

The following accompanying drawings provide a further understanding of the present specification and constitute a part of the specification. The accompanying drawings, together with embodiments described below, are used for explaining, but are not intended to limit, the present specification.

FIG. 1 shows a scanning electron microscope (SEM) atlas of a ternary material prepared according to Embodiment 1 of the present specification at a magnification of 3K;

FIG. 2 shows a scanning electron microscope (SEM) atlas of a ternary material prepared according to Embodiment 1 of the present specification at a magnification of 50K;

FIG. 3 shows a scanning electron microscope (SEM) atlas of a ternary material prepared according to Comparative Embodiment 1 of the present specification at a magnification of 50K; and

FIG. 4 shows a scanning electron microscope (SEM) atlas of a ternary material prepared according to Comparative Embodiment 2 of the present specification at a magnification of 50K.

### DETAILED DESCRIPTION

Embodiments of the present specification are described in detail below. It should be understood that the embodiments described herein are merely for illustrating and describing the present specification and are not intended to limit the present specification.

The endpoints of ranges and any values within ranges disclosed herein are not limited to the precise ranges or values, and such ranges or values should be understood to include values that approximate to the ranges or values. For numeral ranges, the endpoint values of each range, the individual point values within the range, and the individual point values can be combined with one another to create one or more new ranges, and these numerical ranges should be considered as disclosed herein.

In view of the problems in the prior art that the ternary materials prepared by the conventional high-temperature solid phase method or the conventional hydrothermal method cannot balance the electrochemical performance of a lithium battery using the ternary material at low temperature, high temperature, and high rate, the present specification provides a ternary material that has a composition represented by a general formula LiNi_{1-x-y}CoₓM_{y}O₂, wherein the M is Mn or Al, 0<x<1, 0<y<1, and x+y<1. The particles may comprise three-level particles, each particle has a particle diameter ranging from small to large. The three-level particles comprise primary particles having a crystal structure, intermediate particles formed by partial melting of the primary particles, and secondary spheres formed by agglomeration of the intermediate particles.

The “primary particle” and “secondary sphere” in the present specification are all conventional terms in the industry, wherein the “primary particle” is the minimum particle unit in the ternary material particles that have a crystal structure, such as a grain of rice in a rice ball. The “secondary sphere” refers to a particle formed by sintering. The main difference from the prior art is that, the “secondary sphere” in the prior art is agglomerated from primary particles and has no intermediate particles, but the “secondary sphere” in the present specification is agglomerated from intermediate particles.

The “intermediate particle” in the present specification is a new concept proposed for the first time by the present specification. The “intermediate particle” is agglomerated in the secondary sphere and formed by partial melting of a plurality of primary particles. A plurality of intermediate particles is agglomerated in each of the secondary spheres to satisfy the particle diameter requirement of the secondary sphere. The grain boundaries among the intermediate particles agglomerated in the secondary sphere are distinct. Each intermediate particle can be easily distinguished by a scanning electron microscope (SEM) atlas. A plurality of primary particles is fused in each intermediate particle to satisfy the particle diameter requirement of the intermediate particle. The boundary lines of the primary particles fusing each intermediate particle can be seen by a scanning electron microscope (SEM) atlas.

According to the ternary material of the present specification, the ternary material has a composition represented by a general formula LiNi_{1-x-y}CoₓM_{y}O₂, wherein the M is Mn or Al, 0.05≤x≤0.4, and 0.03≤y≤0.5.

According to the ternary material of the present specification, a deintercalation path of lithium ions in the ternary material can be adjusted by controlling the average particle diameter of the primary particles. For the primary particles, an average particle diameter is less than 500 nm or is 10-200 nm. By reducing the size of the primary particle diameter, the deintercalation path of lithium ions in the selected ternary material may further optimize the capacity, low-temperature performance, and rate performance of the lithium battery using the ternary material.

According to the ternary material of the present specification, the compaction density and the energy density of the ternary material can be adjusted by controlling the average particle diameter of the intermediate particles. For the intermediate particles, an average particle diameter is less than 3 μm or is 500 nm-2 am. By adjusting the size of the intermediate particles, the compaction density and the energy density of the ternary material can be increased by reducing the particle diameter of the primary particles. Therefore, the capacity, low-temperature, and rate performance of the lithium battery using the ternary material can be further optimized.

According to the ternary material of the present specification, by controlling the particle sizes and densities of the intermediate layer and the secondary spheres, the specific surface area and porosity of the ternary material with the same weight can be reduced to increase the compaction density of the ternary material and reduce the thermal expansion and resistance change. For the secondary spheres, an average particle diameter is 1-20 jam or is 5-20 am.

According to the ternary material of the present specification, the average particle diameters of the primary particles, the intermediate particles, and the secondary spheres are calculated by measuring the size of 100 target particles in a SEM photograph with a 10K magnification, and then calculating an average of each target particle as the average particle diameter of the particles at that level (i.e., primary particles, the intermediate particles, and the secondary spheres).

According to the ternary material of the present specification, by controlling the particle diameters of the primary particles, the intermediate particles, and the secondary spheres, the overall compaction density of the ternary material can be adjusted to optimize the capacity, low-temperature performance, and rate performance of the lithium battery using the ternary material. For the ternary material, a compaction density is greater than 3.2 g/cm³, greater than 3.3 g/cm³, or 3.4-3.7 g/cm³.

According to the ternary material of the present specification, by adjusting the powder impedance of the ternary material, the thickness and internal resistance change of a ternary material layer on the surface of the anode during high-temperature storage and cycle of the lithium battery can be improved, so as to optimize the high-temperature storage performance and cycle performance of the corresponding lithium battery. When the ternary material is under a pressure of 500 N, for the pure ternary material, a powder impedance may be 0.1-13 kΩ, 0.1-5 kΩ, or 0.1-1 kΩ.

Meanwhile, the present specification further provides a preparation method of a ternary material. The preparation method includes dissolving a soluble nickel salt, a cobalt salt, an M salt, a first lithium source, and an oxidant system in a solvent to prepare a mixed solution, wherein the M is manganese or aluminum. The preparation method further includes promoting an oxidation reaction of the mixed solution. After the reaction occurs, filtering, washing, and drying an oxidation reaction product to obtain a precursor powder, and then mixing a second lithium source into the precursor powder to obtain a mixed powder. The preparation method further includes performing a primary sintering on the mixed powder to obtain secondary spheres, and performing a secondary sintering on the secondary spheres to obtain the ternary material, wherein the temperature of the secondary sintering is higher than the temperature of the primary sintering.

The method provided by the present specification can form the above-mentioned ternary material having three-level particles disclosed in the present specification. Moreover, the method cannot only satisfy the requirement of the ternary material for the lithium salt content, but also reduce the amount of excess lithium salt on the surface of the secondary sphere, by mixing the second lithium source into the precursor powder. Thus, the pH value and powder resistance of the ternary material can be reduced, to further reduce the thickness increment and the internal resistance increment of the battery during high-temperature storage and cycle.

According to the preparation method of the present specification, for the primary particles, an average particle diameter is less than 500 nm or is 10-200 nm. For the intermediate particles, an average particle diameter is less than 3 μm or is 500 nm-2 μm. For the secondary spheres, an average particle diameter is 1-20 μm or is 5-20 μm.

According to the preparation method of the present specification, the oxidant system includes an oxidant and a pH adjusting agent. The process of preparing the mixed solution includes dissolving the nickel salt, the cobalt salt, and the M salt in a solvent to form a solution A, dissolving the oxidant in a solvent to form a solution B, and dissolving the pH adjusting agent and the first lithium source in a solvent to form a solution C. The process further includes mixing the solution A, the solution B, and the solution C, and continuously stirring for 30-60 minutes after mixing to obtain the mixed solution. When both the M salt and the oxidant are potassium permanganate, the potassium permanganate is partially dissolved in the solution A, partially or completely dissolved in the solution B.

According to the preparation method of the present specification, the molar ratio of Ni, Co, and M elements in the mixed solution is (1-x-y):x:y, wherein 0.05≤x≤0.4, and 0.03≤y≤0.5.

According to the preparation method of the present specification, the molar weight of Li in the mixed solution is 1 to 8 times of the total molar weight of Ni, Co, and M. By controlling the molar dosage of the first lithium source within this range, the lithium entering a lattice position can satisfy 70-80% of its required amount.

According to the preparation method of the present specification, the amount of the oxidant is calculated such that a combined valence of Ni, Co, and M in the mixed solution is +3. The oxidant can be selected according to the materials and dosages conventionally employed in the art. In some embodiments, the oxidant is selected from one or more of hydrogen peroxide, potassium permanganate, and sodium thiosulfate. In some embodiments, the pH adjusting agent is selected from one or more of ammonia water, sodium hydroxide, potassium hydroxide, sulfuric acid, nitric acid, and hydrochloric acid. When the oxidant is potassium permanganate, the potassium permanganate can also supply manganese ions to the mixed solution. In this case, the dosage of a manganese source is required to be reduced so that the total molar weight of manganese ions in the mixed solution meets the required amount.

The “combined valence of Ni, Co, and M is +3” as used in the present specification means that the ratio of, the sum of the product of the valence and the mole number of Ni, the product of the valence and the mole number of Co, and the product of the valence and the mole number of M, to the total mole number of Ni, Co, and M, is 3.

According to the preparation method of the present specification, the oxidant is potassium permanganate, the pH adjusting agent is a mixture of sodium hydroxide and ammonia water (NH₃.H₂O), the molar ratio of the sodium hydroxide to the ammonia water is 1-10:1, and the pH adjusting agent is added in an amount such that the pH value of the mixed solution is 8-10.

According to the preparation method of the present specification, the solvent for preparing the solution A, the solution B, and the solution C includes, but is not limited to, one or more of deionized water, ethanol, and acetone. In some embodiments, the solvent is deionized water. Although the concentration of the prepared solution A, solution B, and solution C may not have particular requirements, the concentration of the solution A is 0.1-3 mol/L, the concentration of the solution B is 0.1-3 mol/L, and the concentration of the solution C is 0.1-3 mol/L.

According to the preparation method of the present specification, the solution A, the solution B, and the solution C are stirred and mixed under an inert atmosphere. The inert atmosphere is formed by charging one or more of nitrogen, argon, and helium.

According to the preparation method of the present specification, the conditions for the oxidation reaction may not have specific requirements as long as the reaction of the Ni, Co, and M elements in the mixed solution can be promoted until the combined valence is +3. In some embodiments, the conditions for the oxidation reaction may include charging an oxygen-containing gas into a reactor until the internal pressure of the reactor is 0.6-1.2 Mpa. Then under a sealed condition, raising the internal temperature of the reactor to 170-220° C., and performing a reaction under the constant internal temperature and the constant internal pressure for 8 hours or longer. Under high temperature and high pressure, sufficient reaction and crystallization of lithium, nickel, cobalt, and manganese can be ensured.

According to the preparation method of the present specification, the oxygen-containing gas used in the oxidation reaction may not have particular requirements. The higher oxygen content in the oxygen-containing gas is preferable for a better result. However, in view of the material cost, it is preferable that the oxygen content in the oxygen-containing gas is 50 vol % or above, when the molar weight of Ni in the mixed solution is 50 wt % or above of the total mole number of the Ni, Co, and Mn elements. The oxidation reaction of the Ni element can be better promoted by increasing the oxygen in the oxygen-containing gas, wherein the oxygen-containing gas includes oxygen, air, or a mixed gas thereof.

According to the preparation method of the present specification, drying the reaction product to obtain the precursor powder does not have particular requirements, and may be carried out by a conventional method in the art. For example, but not limited to, vacuum drying, inert gas protection heat drying, freeze drying, flash drying, high speed mixer vacuum drying, spray drying, and the like. Spray drying is preferred in the present specification.

According to the preparation method of the present specification, after the oxidation reaction, filtering and washing of the oxidation reaction product are further included. The filtering and washing process may remove excess Li ions in the oxidation reaction product. In some embodiments, the filtrate produced during filtering is subjected to freezing crystallization treatment to recycle excess lithium salt or the like in the filtrate to avoid waste of materials and reduce material cost. In some embodiments, washing is performed by using deionized water, ethanol, or acetone. The washing liquid obtained during washing can be subjected to freezing crystallization treatment to recycle excess lithium salt in the washing liquid. In the meantime, deionized water having the excess lithium salt (and potassium salt) removed can be reused as the solvent for the preparation of the solutions A, B, and C.

According to the preparation method of the present specification, mixing the second lithium source into the precursor powder further includes measuring the molar weights of Li, Ni, Co, and Mn in the precursor powder (for example, using atomic absorption spectrometry AAS and/or ICP spectrometry), and calculating the molar ratio of Li to the total amount of Ni, Co, and Mn. According to the molar ratio of Li to the total amount of Ni, Co, and Mn, the amount of the second lithium source to be added is calculated such that the molar ratio of Li to the total amount of Ni, Co, and Mn in the mixed powder is (1-1.1):1. The optional second lithium source is mixed with the precursor powder with respect to the determined molar ratio to obtain the mixed powder.

According to the preparation method of the present specification, the conditions for the primary sintering do not have particular requirements, and may be referred to the conventional sintering temperature in the sintering process for the preparation of the secondary spheres (corresponding to primary spheres formed by a primary particle agglomeration in the prior art). The conditions for the primary sintering include sintering at a temperature of 600-900° C. for 8 hours or longer, or 700-800° C. for 8-24 hours, in an oxygen-containing atmosphere.

According to the preparation method of the present specification, the conditions for the secondary sintering may not have particular requirements as long as the temperature is higher than the temperature of the primary sintering. The conditions for the secondary sintering include sintering at 900-1100° C. or 900-1000° C., for 10-60 minutes in an oxygen-containing atmosphere.

According to the preparation method of the present specification, after the primary sintering and the secondary sintering treatments, cooling the produced particles may be further performed. The cooling may be naturally cooling or accelerated cooling by controlling the external temperature.

According to the preparation method of the present specification, a nickel source may be selected from one or more of nickel sulfate, nickel nitrate, and nickel chloride. A cobalt source may be selected from one or more of cobalt sulfate, cobalt nitrate, and cobalt chloride. A manganese source may be selected from one or more of manganese sulfate, manganese nitrate, manganese chloride, and potassium permanganate. Each of the first lithium source and the second lithium source may be selected from one or more of lithium hydroxide, lithium carbonate, lithium chloride, lithium nitrate, and lithium sulfate. In some embodiments, the first lithium source is lithium hydroxide.

According to the preparation method of the present specification, stirring and mixing may be carried out in an optional mechanical mixer, shearing machine, homogenizer, or high-speed mixer.

Furthermore, according to a third aspect of the present specification, a ternary material obtained by the above preparation method is further provided. The ternary material has a composition represented by the general formula LiNi_{1-x-y}CoₓM_{y}O₂, wherein the M is Mn or Al, 0<x<1, 0<y<1, and x+y<1. The particles of the ternary material include three-level particles having a particle diameter range from small to large. The three-level particles include primary particles having a crystal structure, intermediate particles formed by partial melting of a plurality of primary particles, and secondary spheres formed by agglomeration of the intermediate particles. The ternary material prepared by the method has the same structure and properties as those of the ternary material described above.

In addition, according to a fourth aspect of the present specification, a battery slurry is further provided. The battery slurry is a slurry composition prepared by the above ternary material with a solid content of 10-70 wt %. The battery slurry further includes a binder and a conductive agent. The types and dosages of the binder and the conductive agent may be selected according to the conventional configuration in the art. For example, the binder may be polyvinylidene fluoride or the like, and the conductive agent may be acetylene black or the like. The weight ratio of the ternary material, the conductive agent, and the binder is 100:4:4.

According to a fifth aspect of the present specification, an anode is further provided. The anode includes a current collector and an anode material layer disposed on the current collector. The anode material layer includes the ternary material according to the present specification. In some embodiments, the current collector may be made of a conventional conductive metal material used in the art, for example, but not limited to, platinum (Pt) foil, palladium (Pd) foil, aluminum (Al) foil, and the like.

According to a sixth aspect of the present specification, a lithium battery is further provided. The lithium battery includes an anode provided by the present specification. The lithium battery having the above anode provided by the present specification can improve the normal-temperature cycle performance and the high-temperature cycle performance of the battery.

The benefits of the ternary material, the preparation method thereof, the battery slurry, and the lithium battery provided by the present specification will be further described below in conjunction with embodiments and comparative embodiments.

In the following embodiments and comparative embodiments, the average particle diameters of the primary particles, the intermediate particles, and the secondary spheres are measured by measuring the size of 100 target particles on SEM photographs with a 10K magnification, and then averaging the size as the average particle diameter of the particles of that level. The compaction density is measured by dispersing the ternary material, a conductive agent (acetylene black), and a binder (polyvinylidene fluoride) in a solution of N-methyl pyrrolidone (NMP) to form a battery slurry according to a weight ratio of 100:4:4, coating the battery slurry on a smooth aluminum foil having a thickness of 12 jam, drying, die cutting, and tablet compressing under a pressure of 2 Mpa to form an anode with a thickness of 37 am. The weight of the ternary material applied per unit volume on the prepared anode then can be calculated. The powder resistance is measured by compacting the powder under a pressure of 500 N, and directly testing the electrical resistance of the powder under a constant pressure of 500 N.

In the following embodiments and comparative embodiments, the scanning electron microscope (SEM) atlases are obtained by using an S4800 scanning electron microscope at different magnifications. A sample is obtained by sticking the ternary material powder on a conductive tape and performing a metal spraying treatment on it. The sample is dried and stored in a vacuum drying oven before the test.

### Embodiment 1

This embodiment is for explaining the ternary material and the preparation method thereof of the present specification, and the preparation method is specified as follows.

1 mol of NiSO4.6H2O (purity of 99.5%), 1 mol of CoSO4.7H2O (purity of 99.5%), and 0.4 mol of MnSO4.H2O (purity of 99.5%) were dissolved in 15 L of deionized water to form a solution A. 0.6 mol of KMnO4 (purity of 99.7%) was dissolved in 1.5 L of deionized water to form a solution B. 3 mol of LiOH.H2O, 6 mol of NaOH, and 0.6 mol of NH3.H2O were dissolved in 15 L of deionized water to form a solution C. While were synchronously added dropwise into a reactor by separate metering pumps, the solutions A, B, and C were stirred for reacting under an atmospheric protection with N2. After were completely added, the solutions was stirred continuously for 30 minutes to form a mixed solution (pH value of 8.5). The obtained mixed solution was then pumped into a 50 L high-pressure reactor (filling volume of approximately 70%). Then, air (the oxygen content of air was 20.947 vol %) was charged into the reactor to reach a pressure of 0.8 MPa for a 24 hours oxidation reaction at a temperature of 200° C. After naturally cooling, the slurry was filtered and washed with deionized water for three times. Finally, the slurry was subjected to spray granulation by a spray dryer (the inlet temperature was 260° C., and the air outlet temperature was 110° C.) to obtain the precursor powder D (an average particle diameter of 103 nm).

The molar weights of Li, Ni, Co, and Mn in the precursor powder D were measured by a combination of AAS and IPC, and the molar ratio of Li, Ni, Co, and Mn was calculated to be 0.78:0.34:0.33:0.33. 0.14 mol of Li2CO3 (purity of 99.5%) was added and mixed into 1 mol of the precursor powder D (Li0.78Ni1/3Co1/3Mn1/3O2) to form the mixed powder, and the mixed powder was charged into a crucible. In a tube furnace, compressed air was introduced, the mixed powder was sintered at a constant temperature of 800° C. for 14 hours and then at a temperature of 960° C. for 20 minutes. A Li1.06Ni1/3Co1/3Mn1/3O2 material was obtained after naturally cooling.

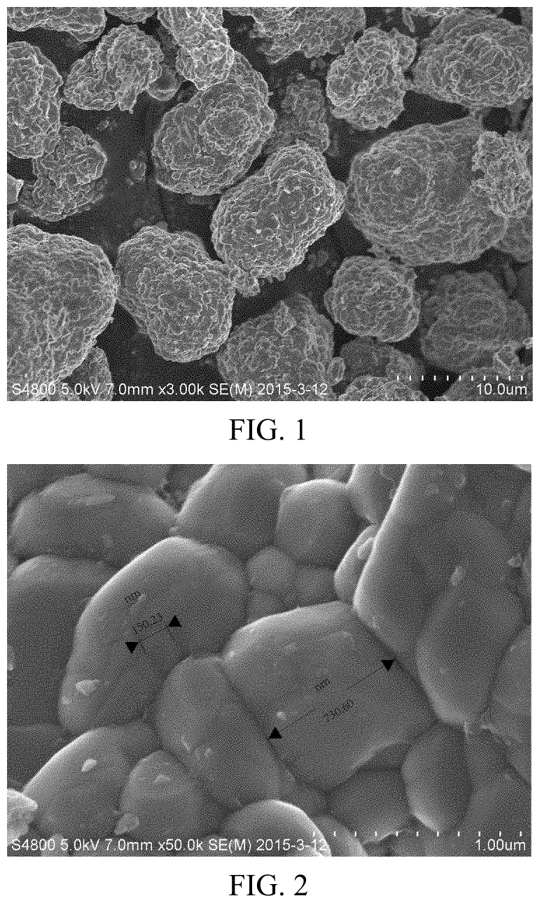

FIG. 1 and FIG. 2 are scanning electron microscope (SEM) atlases of the Li1.06Ni1/3Co1/3Mn1/3O2 material prepared as described above at different magnifications. It can be seen from FIG. 1 that the size of the secondary spheres of the Li1.06NiCoMnO2 material was relatively uniform, and the average particle diameter of the secondary spheres was calculated as 11.2 μm. It can be seen from FIG. 2 that the secondary spheres of the Li1.06Ni1/3Co1/3Mn1/3O2 material were agglomerated from intermediate particles, and the intermediate particles had distinct boundary lines of crystals having the primary particle diameter. The average particle diameter of the intermediate particles was calculated as 896 nm, and the average particle diameter of the primary particles was calculated as 142 nm. The Li1.06Ni1/3Co1/3Mn1/3O2 material prepared as described above had a compaction density of 3.56 g/cm³ and a powder impedance of 0.2 KΩ.

### Embodiment 2

This embodiment is for explaining the ternary material and the preparation method thereof of the present specification. The preparation method is specified as follows.

1.5 mol of NiSO4.6H2O (purity of 99.5%), 0.6 mol of CoSO4.7H2O (purity of 99.5%), and 0.45 mol of MnSO4.H2O (purity of 99.5%) were dissolved in 15 L of deionized water to form a solution A. 0.45 mol of KMnO4 was dissolved in 1.5 L of deionized water to form a solution B. 6 mol of LiOH.H2O, 6 mol of NaOH, and 0.9 mol of NH3.H2O were dissolved in 15 L of deionized water to form a solution C. While were synchronously added dropwise into a reactor by separate metering pumps, the solutions A, B and C were stirred for reacting under an atmospheric protection with N2. After the solutions were completely added, stirring was continued for 30 minutes to form a mixed solution (pH value of 8.8). The obtained mixed solution was then pumped into a 50 L high-pressure reactor (filling volume of approximately 70%). Then, pure oxygen gas (the oxygen content was 99.999%) was charged to the reactor to reach a pressure of 0.6 MPa for a 20 hours oxidation reaction at a temperature of 220° C. After naturally cooling, the slurry was filtered and washed with deionized water for three times. Finally, the slurry was subjected to spray granulation by a spray dryer (the inlet temperature was 260° C., and the air outlet temperature was 110° C.) to obtain the precursor powder D (an average particle diameter of 122 nm).

The molar weights of Li, Ni, Co, and Mn in the precursor powder D were measured by a combination of AAS and IPC, and the molar ratio of Li, Ni, Co, and Mn was calculated to be 0.81:0.51:0.19:0.30. 1 mol of the precursor powder D and 0.099 mol of Li2CO3 (purity of 99.7%) were mixed to form mixed powder, and the mixed powder was charged into a crucible. In a tube furnace, compressed air was introduced, the mixed powder was sintered at a constant temperature of 700° C. for 20 hours, and then at the temperature of 900° C. for 30 minutes. A Li1.04Ni0.51Co0.19Mn0.3O2 material was obtained after naturally cooling.

From the scanning electron microscope (SEM) atlases of the Li1.04Ni0.51Co0.19Mn0.3O2 material prepared as described above at different magnifications, an average particle diameter of the secondary spheres of the Li1.04Ni0.51Co0.19Mn0.3O2 material was calculated as 12.4 μm, an average particle diameter of the intermediate particles was calculated as 893 nm, and an average particle diameter of the primary particles was calculated as 126 nm. It was detected that the Li1.04Ni0.51Co0.19Mn0.3O2 material prepared as described above had a compaction density of 3.61 g/cm³ and a powder impedance of 0.24 KΩ.

### Embodiment 3

This embodiment is for explaining the ternary material and the preparation method thereof of the present specification. The preparation method is specified as follows.

1.8 mol of NiSO4.6H2O (purity of 99.5%), 0.6 mol of CoSO4.7H2O (purity of 99.5%), and 0.45 mol of MnSO4.H2O (purity of 99.5%) were dissolved in 15 L of deionized water to form a solution A. 0.15 mol of KMnO4 was dissolved in 1.5 L of deionized water to form a solution B. 24 mol of LiOH.H2O, 6 mol of NaOH, and 0.9 mol of NH3.H2O were dissolved in 15 L of deionized water to form a solution C. While were synchronously added dropwise into a reactor by separate metering pumps, the solutions A, B and C were stirred for reacting under an atmospheric protection with N2. After solutions were completely added, the solutions was stirred continuously for 30 minutes to form a mixed solution (pH value of 9.6). The obtained mixed solution was then pumped into a 50 L high-pressure reactor (filling volume of approximately 70%). Then, pure oxygen gas (the oxygen content was 99.999 wt %) was charged to the reactor to reach a pressure of 1.2 MPa for a 10 hours oxidation reaction at a temperature of 170° C. After naturally cooling, the slurry was filtered and washed with deionized water for three times. Finally, the slurry was subjected to spray granulation by a spray dryer (the inlet temperature was 260° C., and the air outlet temperature was 110° C.) to obtain a precursor powder D (an average particle diameter of 114 nm).

The molar weights of Li, Ni, Co, and Mn in the precursor powder D were measured by a combination of AAS and IPC, and the molar ratio of Li, Ni, Co, and Mn was calculated to be 0.86:0.61:0.19:0.20. 1 mol of the precursor powder D and 0.08 mol of Li2CO3 (purity of 99.7%) were mixed to form a mixed powder, and the mixed powder was charged into a crucible. In a tube furnace, compressed air was introduced to reach a pressure of 0.8 MPa, the mixed powder was sintered at a constant temperature of 750° C. for 12 hours and then at a temperature of 1000° C. for 15 minutes. A Li1.02Ni0.61Co0.19Mn0.202 material was obtained after naturally cooling.

From the scanning electron microscope (SEM) atlases of the Li1.02Ni0.61Co0.19Mn0.202 material prepared as described above at different magnifications, an average particle diameter of the secondary spheres of the Li1.02Ni0.61Co0.19Mn0.202 material was calculated as 12.6 am, an average particle diameter of the intermediate particles was calculated as 884 nm, and an average particle diameter of the primary particles was calculated as 118 nm. It was detected that the Li1.02Ni0.61Co0.19Mn0.202 material prepared as described above had a compaction density of 3.61 g/cm³ and a powder impedance of 0.3 KΩ.

### Embodiment 4

This embodiment is for explaining the ternary material and the preparation method thereof of the present specification. The preparation method is specified as follows.

2.1 mol of NiSO4.6H2O (purity of 99.5%) and 0.45 mol of CoSO4.7H2O (purity of 99.5%) were dissolved in 15 L of deionized water to form a solution A. 0.45 mol of KMnO4 was dissolved in 1.5 L of deionized water to form a solution B. 3 mol of LiOH.H2O, 10.5 mol of Li2SO4, 6 mol of NaOH, and 1.2 mol of NH3.H2O were dissolved in 15 L of deionized water to form a solution C. While were synchronously added dropwise into a reactor by separate metering pumps, the solutions A, B and C were stirred for reacting under an atmospheric protection with N2. After were completely added, the solutions was stirred continuously for 30 minutes to form a mixed solution (pH value of 8.6). The obtained mixed solution was then pumped into a 50 L high-pressure reactor (filling volume of approximately 70%). Then, pure oxygen gas (the oxygen content was 99.999 wt %) was charged to the reactor to reach a pressure of 0.8 MPa for a 20 hours oxidation reaction at a temperature of 183° C. After naturally cooling, the slurry was filtered and washed with deionized water for three times. Finally, the slurry was subjected to spray granulation by a spray dryer (the inlet temperature was 260° C., and the air outlet temperature was 110° C.) to obtain a precursor powder D (an average particle diameter of 128 nm).

The molar weights of Li, Ni, Co, and Mn in the precursor powder D were measured by a combination of AAS and IPC, and the molar ratio of Li, Ni, Co, and Mn was calculated to be 0.74:0.70:0.15:0.15. 1 mol of the precursor powder D and 0.28 mol of LiOH (purity of 99.27%) were mixed to form a mixed powder, and the mixed powder was charged into a crucible. In a tube furnace, pure oxygen gas having a purity of 99.999% was introduced, the mixed powder was sintered at a constant temperature of 780° C. for 24 hours, then at a temperature of 910° C. for 20 minutes. A Li1.02Ni0.7Co0.15Mn0.15O2 material was obtained after naturally cooling.

From the scanning electron microscope (SEM) atlases of the Li1.02Ni0.7Co0.15Mn0.15O2 material prepared as described above at different magnifications, an average particle diameter of the secondary spheres of the Li1.02Ni0.7Co0.15Mn0.1502 material can be calculated as 12.9 μm, an average particle diameter of the intermediate particles was calculated as 927 nm, and an average particle diameter of the primary particles was calculated as 134 nm. It was detected that the Li1.02Ni0.7Co0.15Mn0.15O2 material prepared as described above had a compaction density of 3.62 g/cm³ and a powder impedance of 0.19 KΩ.

### Embodiment 5

This embodiment is for explaining the ternary material and the preparation method thereof of the present specification. The preparation method is specified as follows.

2.4 mol of NiSO4.6H2O (purity of 99.5%) and 0.3 mol of CoSO4.7H2O (purity of 99.5%) were dissolved in 15 L of deionized water to form a solution A. 0.3 mol of KMnO4 was dissolved in 1.5 L of deionized water to form a solution B. 9 mol of LiOH.H2O, 7.5 mol of Li2SO4, 7.5 mol of NaOH, and 0.9 mol of NH3.H2O were dissolved in 15 L of deionized water to form a solution C. While were synchronously added dropwise into a reactor by separate metering pumps, the solutions A, B and C were stirred for reacting under an atmospheric protection with N2. After were completely added, the solutions was stirred continuously for 30 minutes to form a mixed solution (pH value of 9.0). The obtained mixed solution was then pumped into a 50 L high-pressure reactor (filling volume of approximately 70%). Then, pure oxygen gas (the oxygen content was 99.999 wt %) was charged to the reactor to reach a pressure of 0.8 MPa for a 24 hours oxidation reaction at a temperature of 180° C. After naturally cooling, the slurry was filtered and washed with deionized water for three times. Finally, the slurry was subjected to spray granulation by a spray dryer (the inlet temperature was 260° C., and the air outlet temperature was 110° C.) to obtain the precursor powder D (an average particle diameter of 102 nm).

The molar weights of Li, Ni, Co, and Mn in the precursor powder D were measured by a combination of AAS and IPC, and the molar ratio of Li, Ni, Co, and Mn was calculated to be 0.70:0.79:0.11:0.1. 1 mol of the precursor powder D and 0.31 mol of LiOH (purity of 99.27%) were mixed to form a mixed powder, and the mixed powder was charged into a crucible. In a tube furnace, pure oxygen gas having a purity of 99.999% was introduced, the mixed powder was sintered at a constant temperature of 760° C. for 18 hours, and then at a temperature of 900° C. for 20 minutes. A Li1.01Ni0.79Co0.11Mn0.1O2 material was obtained after naturally cooling.

From the scanning electron microscope (SEM) atlases of the Li1.01Ni0.79Co0.11Mn0.1O2 material prepared as described above at different magnifications, an average particle diameter of the secondary spheres of the Li1.01Ni0.79Co0.11Mn0.1O2 material can be calculated as 13.7 μm, an average particle diameter of the intermediate particles was calculated as 706 nm, and an average particle diameter of the primary particles was calculated as 140 nm. It was detected that the Li1.01Ni0.79Co0.11Mn0.1O2 material prepared as described above had a compaction density of 3.56 g/cm³ and a powder impedance of 0.43 KΩ.

### Embodiment 6

This embodiment is for explaining the ternary material and the preparation method thereof of the present specification. The preparation method is specified as follows. Different than Embodiment 1, after the mixed powder was charged into a crucible, compressed air was introduced in a tube furnace. The mixed powder was sintered at a constant temperature of 900° C. for 14 hours, and then at a temperature of 1100° C. for 30 minutes. A Li1.06Ni1/3Co1/3Mn1/3O2 material was obtained after naturally cooling.

From the scanning electron microscope (SEM) atlases of the Li1.06Ni1/3Co1/3Mn1/3O2 material prepared as described above at different magnifications, an average particle diameter of the secondary spheres of the Li1.06Ni1/3Co1/3Mn1/3O2 material can be calculated as 12.4 am, an average particle diameter of the intermediate particles was calculated as 2.6 am, and an average particle diameter of the primary particles was calculated as 226 nm. It was detected that the Li1.06Ni1/3Co1/3Mn1/3O2 material prepared as described above had a compaction density of 3.6 g/cm³ and a powder impedance of 0.3 KΩ.

### Embodiment 7

This embodiment is for explaining the ternary material and the preparation method thereof of the present specification. The preparation method is specified as follows.

2.46 mol of NiSO4.6H2O (purity of 99.5%), 0.45 mol of CoSO4.7H2O (purity of 99.5%), and 0.03 mol of Al3(SO4)2 (purity of 99.5%) were dissolved in 15 L of deionized water to form a solution A. 0.45 mol of sodium thiosulfate was dissolved in 1.5 L of deionized water to form a solution B. 24 mol of LiOH.H2O, 6 mol of NaOH, and 0.9 mol of NH3.H2O were dissolved in 15 L of deionized water to form a solution C. While were synchronously added dropwise into a reactor by separate metering pumps, the solutions A, B, and C were stirred for reacting under an atmospheric protection with N2. After were completely added, the solutions was stirred continuously for 30 minutes to form a mixed solution (pH value of 9.7). The obtained mixed solution was then pumped into a 50 L high-pressure reactor (filling volume of approximately 70%). Then, pure oxygen gas (the oxygen content was 99.999 wt %) was charged in to the reactor to reach a pressure of 1.5 MPa for a 24 hours oxidation reaction at a temperature of 180° C. After naturally cooling, the slurry was filtered and washed with deionized water for three times. Finally, the slurry was subjected to spray granulation by a spray dryer (the inlet temperature was 260° C., and the air outlet temperature was 110° C.) to obtain a precursor powder D (an average particle diameter of 146 nm).

The molar weights of Li, Ni, Co, and Mn in the precursor powder D were measured by a combination of AAS and IPC, and the molar ratio of Li, Ni, Co, and Al was calculated to be 0.8:0.82:0.15:0.03. 1 mol of the precursor powder D and 0.21 mol of LiOH (purity of 99.27%) were mixed to form a mixed powder, and the mixed powder was charged into a crucible. In a tube furnace, pure oxygen gas having a purity of 99.999% was introduced, the mixed powder was sintered at a constant temperature of 760° C. for 18 hours, then at a temperature of 900° C. for 10 minutes. A Li1.01Ni0.82Co0.15Al0.03O2 material was obtained after naturally cooling.

From the scanning electron microscope (SEM) atlases of the Li1.01Ni0.82Co0.15Al0.03O2 material prepared as described above at different magnifications, an average particle diameter of the secondary spheres of the Li1.01Ni0.82Co0.15Al0.03O2 material can be calculated as 14.2 μm, an average particle diameter of the intermediate particles was calculated as 1135 nm, and an average particle diameter of the primary particles was calculated as 153 nm. It was detected that the Li1.01Ni0.82Co0.15Al0.03O2 material prepared as described above had a compaction density of 3.64 g/cm³ and a powder impedance of 0.11 KΩ.

### Comparative Embodiment 1

This comparative embodiment is for explaining the ternary material and the preparation method thereof of the present specification as a comparison. The preparation method is specified as follows.

1 mol of NiSO4.6H2O (purity of 99.5%), 1 mol of CoSO4.7H2O (purity of 99.5%), and 1 mol of MnSO4.H2O (purity of 99.5%) were dissolved in 15 L of deionized water to form a solution A. 6 mol of NaOH and 0.6 mol of NH3.H2O were dissolved in 15 L of deionized water to form a solution B. While were synchronously added dropwise into a reactor by separate metering pumps, the solutions A, B, and C were stirred for reacting under an atmospheric protection with N2. After were completely added, the solutions was stirred continuously for 180 minutes to form a mixed solution. An obtained precipitate was filtered and washed with deionized water for three times, and then dried in a vacuum oven at 110° C. under the protection of N2 for 24 hours to obtain a precursor powder C (the average particle diameter of the secondary sphere was 12 μm).

The molar weights of Ni, Co, and Mn in the precursor powder C were measured by a combination of AAS and IPC, and the molar ratio of Ni, Co, and Mn was calculated to be 0.34:0.33:0.33. 0.53 mol of Li2CO3 (purity of 99.5%) was added and mixed into 1 mol of the precursor powder C to form a mixed powder, and the mixed powder was charged into a crucible. In a tube furnace, compressed air was introduced, the mixed powder was sintered at a constant temperature of 950° C. for 14 hours. A Li1.06Ni1/3Co1/3Mn1/3O2 material was obtained after naturally cooling.

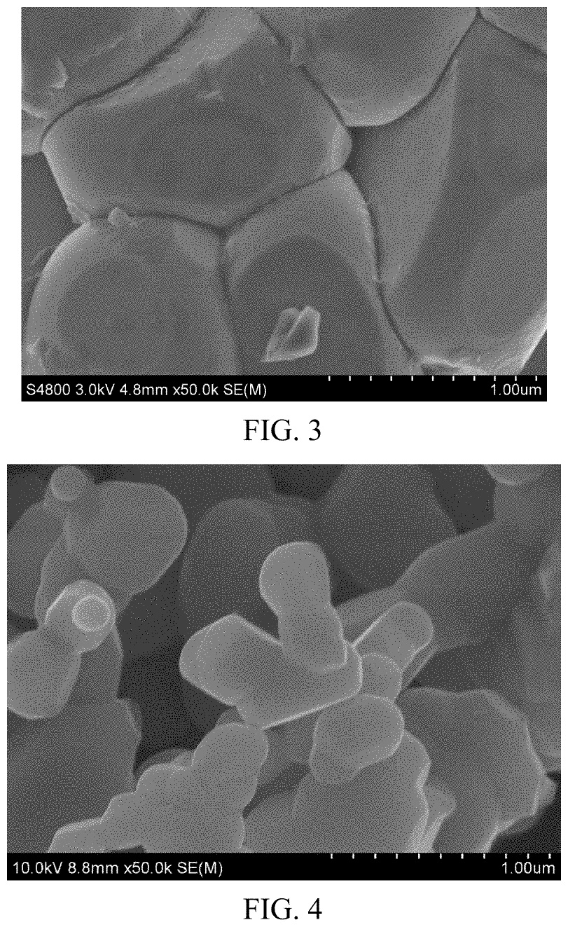

It can be seen from FIG. 3 that the Li1.06Ni1/3Co1/3Mn1/3O2 material was composed of two-level particles including minimum primary particles and secondary spheres formed by agglomeration of the primary particles. No intermediate particle was present in the Li1.06Ni1/3Co1/3Mn1/3O2 material. It can be seen from the figure that the primary particles was larger and have the average particle size of 532 nm, while the average particle diameter of the secondary spheres was about 12.4 am. The Li1.06Ni1/3Co1/3Mn1/3O2 material prepared as described above had a compaction density of 3.59 g/cm³ and a powder impedance of 26 KΩ.

### Comparative Embodiment 2

This comparative embodiment is for explaining the ternary material and the preparation method thereof of the present specification as a reference. The preparation method is specified as follows.

40 mol of an anode precursor Ni0.5Co0.2Mn0.3(OH)2, 40 mol of LiOH, and 20 L of pure water were added to a high-pressure reactor, and then the temperature of the precursor was raised to 220° C. After 2 hours at the constant temperature of 220° C., 30 mol of hydrogen peroxide was added into the reactor by a booster pump. After keeping at the constant temperature for 5 hours, the precursor was cooled down to the room temperature, and subject to pressure filtration and wash to obtain a product to be sintered. The product was added to a muffle furnace, and heated at a rate of 5° C./min at a pure oxygen flow rate of 0.8 m3/h. Then, the product was sintered at a constant temperature of 50° C. for 2 hours and then at a constant temperature of 100° C. for 2 hours. The product was rapidly heated to 500° C., was sintered at a constant temperature for 4 hours, and then at a constant temperature of 780° C. for 16 hours. A LiNi0.5Co0.2Mn0.3O2 anode material was obtained.

It can be seen from FIG. 4 that the LiNi0.5Co0.2Mn0.3O2 material had the minimum primary particles. The primary particles were relatively loose and did not form a tightly agglomerated secondary sphere structure. It was calculated that the primary particles had an average particle diameter of 121 nm. The LiNi0.5Co0.2Mn0.3O2 material prepared as described above had a compaction density of 1.8 g/cm³ and a powder impedance of 15 KΩ.

### Comparative Embodiment 3

This comparative embodiment is for explaining the ternary material and the preparation method thereof of the present specification as a reference. The preparation method of the ternary material is specified as follows: with reference to the method in Embodiment 2, after the mixed powder was formed, the mixed powder was charged into a crucible. In a tube furnace, compressed air was introduced, the mixed powder was sintered at a constant temperature of 960° C. for 24 hours. A Li1.04Ni0.51Co0.19Mn0.3O2 material was obtained after naturally cooling.

It can be seen from the scanning electron microscope (SEM) atlases of the Li1.04Ni0.51Co0.19Mn0.3O2 material prepared as described above at different magnifications, that the Li1.01Ni0.82Co0.15Al0.03O2 material was composed of two-level particles including minimum primary particles and secondary spheres formed by agglomeration of the primary particles. No intermediate particle was present. It can be seen from the figure that the secondary spheres had an average particle diameter of 12.9 μm, and the primary particles had an average particle diameter of 659 nm. It was detected that the Li1.01Ni0.82Co0.15Al0.03O2 material prepared as described above had a compaction density of 3.5 g/cm³ and a powder impedance of 0.4 KΩ.

### Comparative Embodiment 4

This comparative embodiment is for explaining the ternary material and the preparation method thereof of the present specification as a reference. The preparation method of the ternary material is specified as follows: with reference to the method in Embodiment 1, the procedure that Li2CO3 was added and mixed to the precursor powder D to form mixed powder was eliminated. The precursor powder D was directly charged into the crucible to for the subsequent sintering procedure.

From the scanning electron microscope (SEM) atlases of the Li0.78Ni1/3Co1/3Mn1/3O2 material prepared as described above at different magnifications, an average particle diameter of the secondary spheres of the Li0.78Ni1/3Co1/3Mn1/3O2 material can be calculated as 12.2 μm, an average particle diameter of the intermediate particles was calculated as 903 nm, and an average particle diameter of the primary particles was calculated as 124 nm. It was detected that the Li0.78Ni1/3Co1/3Mn1/3O2 material prepared as described above had a compaction density of 3.62 g/cm³ and a powder impedance of 18 KΩ.

### Application Embodiment

(1) Preparation of Battery Slurry, Anode, and Lithium Battery.

In the ternary material prepared in Embodiments 1 to 7 and Comparative Embodiments 1 to 4, a conductive agent (acetylene black) and a binder (polyvinylidene fluoride) were dispersed in a solution of N-methyl pyrrolidone (NMP) according to a weight ratio of 100:4:4 to form a battery slurry.

The battery slurry was coated on smooth aluminum foil having a thickness of 12 μm, and is subject to drying, die cutting, and tablet compressing under a pressure of 2 Mpa to form an anode with a thickness of 37 μm.

A 053450 type single cell battery was fabricated using the anode. In the battery, the negative electrode material was natural graphite, the separator material was a Celgard PE film commercially available from Celgard. The negative electrolyte was 1 mol/L LiPF6/(EC+DMC), wherein the LiPF6 was lithium hexafluorophosphate, EC was ethylene carbonate, DMC was dimethyl carbonate, and the volume ratio of EC to DMC was 1:1.

The batteries fabricated using the ternary materials prepared in Embodiments 1 to 7 and Comparative Embodiments 1 to 4 were designated as S1 to S7 and D1 to D4, respectively.

(2) Electrochemical Performance Test.

The test items and methods are as follows.

−20° C. capacity retention rate test: at room temperature and a rate of 1 C, the battery was charged at a constant current to 4.3 V, kept at a constant voltage of 4.3 V until a current of 0.1 C, then discharged at a constant current to 2.5 V at the rate of 1 C. Subsequently, the battery was charged at a constant current to 4.3 V at the rate of 1 C, kept at a constant voltage of 4.3 V until a current of 0.1 C. The battery was then placed in a freezer at −20° C., and discharged at a constant current to 2.5 V at the rate of 1 C. At this time, a ratio of the discharge capacity at −20° C. to the discharge capacity at room temperature was the low-temperature capacity retention rate of the battery.

Discharge capacity retention rate test at a rate of 5 C: the battery was charged under CCCV to 4.3 V at a rate of 0.2 C, with a cut-off current of 0.02 C, and then discharged under CC to 2.5 V at the rate of 5 C. A ratio of the discharge capacity at the rate of 5 C to the discharge capacity at the rate of 0.2 C was the discharge rate efficiency at the rate of 5 C.

60° C., 30-day capacity recovery rate test: the battery was fully charged at 0.5 CCCV, stored in a 60° C. oven for 30 days, taken out and discharged to 2.5 V at 0.5 C, charged at 0.5 CCCV to 4.3 V, and discharged to 2.5V. A ratio of the charge capacity after high-temperature storage to the charge capacity before the storage of the battery was the high-temperature storage capacity recovery rate of the battery.

60° C., 1 C, 500-cycles capacity retention rate test: in the environment of 60° C., at a rate of 1 C, after the battery had undergone 500 charge and discharge cycles, a ratio of the capacity of the 500th cycle to the capacity of the 1st cycle was the high-temperature cycle capacity retention rate of the battery.

Battery thickness increase: in an environment of 60° C., at a rate of 1 C, after the battery had undergone 500 charge and discharge cycles, a difference between the thickness of the 500th cycle and the thickness of the 1st cycle was the thickness change value of the battery.

Battery internal resistance increase test: in an environment of 60° C., at a rate of 1 C, after the battery had undergone 500 charge and discharge cycles, a difference between the battery resistance of the 500th cycle and the battery resistance of the 1st cycle was the internal resistance change value of the battery.

Test results: as shown in Table 1 and Table 2.

TABLE 1

| | S1 | S2 | S3 | S4 | S5 |
|---|---|---|---|---|---|
| −20° C. capacity retention rate (%) | 66 | 65.3 | 65.4 | 62.2 | 62.1 |
| Discharge capacity retention rate at rate of 5 C (%) | 95 | 94.1 | 94.2 | 93.1 | 92.3 |
| 60° C., 30-day capacity recovery rate (%) | 98.2 | 96.1 | 94.7 | 93.6 | 92.7 |
| 60° C., 1 C, 500-cycles capacity retention rate (%) | 87.8 | 87.5 | 87.2 | 84.6 | 82.3 |
| 60° C., 1 C, 500-cycles battery thickness increase | 0.19 | 0.2 | 0.22 | 0.26 | 0.28 |
| (mm) | | | | | |
| 60° C., 1 C, 500-cycles battery internal resistance | 1.5 | 1.6 | 1.6 | 1.9 | 2.1 |
| increase (mΩ) | | | | | |

TABLE 2

| | S6 | S7 | D1 | D2 | D3 | D4 |
|---|---|---|---|---|---|---|
| −20° C. capacity retention | 63.8 | 64.2 | 52.7 | 60.4 | 54.6 | 54.3 |
| rate (%) | | | | | | |
| Discharge capacity retention | 93.4 | 93.6 | 82.7 | 91.5 | 84.6 | 86.4 |
| rate at rate of 5 C (%) | | | | | | |
| 60° C., 30-day capacity | 94.4 | 91.9 | 92.8 | 84.3 | 92.4 | 88.5 |
| recovery rate (%) | | | | | | |
| 60° C., 1 C, 500-cycles | 83.8 | 81.7 | 87.1 | 80.3 | 86.9 | 81.2 |
| capacity retention rate (%) | | | | | | |
| 60° C., 1 C, 500-cycles | 0.27 | 0.28 | 0.24 | 0.37 | 0.31 | 0.32 |
| battery thickness increase | | | | | | |
| (mm) | | | | | | |
| 60° C., 1 C, 500-cycles | 2.2 | 2.2 | 1.8 | 2.6 | 2.3 | 2.5 |
| battery internal resistance | | | | | | |
| increase (mΩ) | | | | | | |

It can be seen that as compared with the batteries D1-D4, the batteries S1-S7 prepared by using the particles of the ternary material provided by the present specification have the following technical features.

(1) By forming the primary particles and utilizing the characteristic of smaller particle diameter of the primary particles, the ternary material has a short lithium ion deintercalation path, thereby optimizing the low-temperature performance and rate performance of the lithium battery using the ternary material.

(2) By forming the secondary spheres, the primary particles are agglomerated together to reduce the specific surface area and porosity of the ternary material under the same mass, to increase the compaction density of the ternary material and reduce thermal expansion and resistance change, thereby improving the safety of the lithium battery using the ternary material.

(3) By forming the intermediate particles, the loose primary particles agglomerated in the secondary spheres can be partially fused together to increase the compaction density and energy density of the ternary material, and to optimize the heat storage performance and thermal cycle performance of the lithium battery using the ternary material.

(4) By including three-level particles in the particles of the ternary material, the ternary material benefits from excellent low-temperature and rate performance of small particles and good high-temperature storage and high-temperature cycle performance of large particles.

The preferable embodiments of the present specification have been described in detail above. But the present specification is not limited to the specific details described in the above embodiments. Any variations of the technical solutions of the present specification within the scope of the technical principle of the present specification shall be all protected within the scope of the present specification.

It should be further noted that the technical features described in the above embodiments may be combined in any suitable manner under non-contradicted conditions. To avoid unnecessary repetition, other possible embodiments will not be described in this specification.

In addition, the embodiments of the present specification may be in any combination as long as it does not deviate from the principle of the present specification, and the combination shall also be considered as the disclosure of the present specification.

1. A ternary material, comprising:
a composition represented by a formula LiNi_{1-x-y}CoₓM_{y}O₂, wherein the M is Mn or Al, 0<x<1, 0<y<1, and x+y<1; and
particles of the ternary material comprising three-level particles having a particle diameter range from small to large, wherein the three-level particles comprise primary particles having a crystal structure, intermediate particles formed by partial melting of a plurality of the primary particles, and secondary spheres formed by agglomeration of the intermediate particles.

2. The ternary material according to claim 1, wherein in the formula LiNi_{1-x-y}CoₓM_{y}O₂, 0.05≤x≤0.4, and 0.03≤y≤0.5.

3. The ternary material according to claim 1, wherein
the primary particles have an average particle diameter of less than 500 nm,
the intermediate particles have an average particle diameter of less than 3 μm, and
the secondary spheres have an average particle diameter of 1 μm-20 μm.

4. The ternary material according to claim 1, wherein
the primary particles have an average particle diameter of 10-200 nm,
the intermediate particles have an average particle diameter of 500 nm-2 μm, and
the secondary spheres have an average particle diameter of 5-20 μm.

5. The ternary material according to claim 1, wherein the ternary material has a compaction density greater than 3.2 g/cm³.

6. The ternary material according to claim 1, wherein the ternary material has a compaction density of 3.4-3.7 g/cm³.

7. The ternary material according to claim 1, wherein the ternary material has a powder impedance of 0.1-13 KΩ.

8. The ternary material according to claim 1, wherein the ternary material has a powder impedance of 0.1-5 KΩ.

9. The ternary material according to claim 1, wherein the ternary material has a powder impedance of 0.1-1 KΩ.

10. A preparation method of a ternary material, comprising:
preparing a mixed solution by dissolving a soluble nickel salt, a cobalt salt, an M salt, a first lithium source, and an oxidant system in a solvent, wherein the M is manganese or aluminum;
promoting an oxidation reaction of the mixed solution, after the reaction, filtering, washing, and drying an oxidation reaction product to obtain a precursor powder, and mixing a second lithium source into the precursor powder to obtain a mixed powder;
performing primary sintering on the mixed powder to obtain secondary spheres; and
performing secondary sintering on the secondary spheres to obtain the ternary material;
wherein, a temperature of the secondary sintering is higher than a temperature of the primary sintering.

11. The preparation method according to claim 10, wherein primary particles have an average particle diameter of less than 500 nm, intermediate particles have an average particle diameter of less than 3 μm, and the secondary spheres have an average particle diameter of 1-20 μm.

12. The preparation method according to claim 11, wherein the primary particles have an average particle diameter of 10-200 nm, the intermediate particles have an average particle diameter of 500 nm-2 μm, and the secondary spheres have an average particle diameter of 5-20 μm.

13. The preparation method according to claim 10, wherein
the oxidant system comprises an oxidant and a pH adjusting agent, and
preparing a mixed solution comprises:
dissolving the nickel salt, the cobalt salt, and the M salt in the solvent to form a solution A;
dissolving the oxidant in the solvent to form a solution B;
dissolving the pH adjusting agent and the first lithium source in the solvent to form a solution C; and
mixing the solution A, the solution B, and the solution C, and continuously stirring for 30-60 minutes after mixing to obtain the mixed solution;
wherein, when both the M salt and the oxidant are potassium permanganate, the potassium permanganate is partially dissolved in the solution A, and partially or completely dissolved in the solution B.

14. The preparation method according to claim 13, wherein a molar ratio of Ni, Co, and M elements in the mixed solution is (1-x-y):x:y, wherein 0.05≤x<0.4, 0.03≤y<0.5, and a molar weight of Li in the mixed solution is 1 to 8 times a total molar weight of Ni, Co, and M.

15. (canceled)

16. The preparation method according to claim 13, wherein an amount of the oxidant in the solution is determined, such that a combined valence of Ni, Co, and M in the mixed solution is +3.

17. The preparation method according to claim 13, wherein the oxidant is selected from one or more of hydrogen peroxide, potassium permanganate, and sodium thiosulfate, and the pH adjusting agent is selected from one or more of ammonia water, sodium hydroxide, potassium hydroxide, sulfuric acid, nitric acid, and hydrochloric acid.

18. (canceled)

19. The preparation method according to claim 10, wherein promoting the oxidation reaction of the mixed solution comprises:
charging an oxygen-containing gas into a reactor until an internal pressure of the reactor is 0.6-1.2 Mpa;
under a sealed condition, raising an internal temperature of the reactor to 170-220° C.; and
performing the oxidation reaction under constant temperature and constant pressure for 8 hours or longer.

20. The preparation method according to claim 10, wherein mixing the second lithium source into the precursor powder to obtain a mixed powder comprises:
measuring a molar weights of Li, Ni, Co, and Mn in the precursor powder;
calculating a molar ratio of Li to the total amount of Ni, Co, and Mn;
according to the molar ratio of Li to the total amount of Ni, Co, and Mn, calculating an amount of the second lithium source to be added to the precursor powder, wherein the molar ratio of Li to the total amount of Ni, Co, and Mn in the mixed powder is (1-1.1):1; and
mixing the precursor powder with the calculated amount of the second lithium source to obtain the mixed powder.

21. The preparation method according to claim 10, wherein
performing primary sintering on the mixed powder to obtain the secondary spheres comprises sintering at a temperature of 600° C.-900° C. for 8 hours or longer in an oxygen-containing atmosphere, and
performing secondary sintering on the secondary spheres to obtain the ternary material comprises sintering at a temperature of 900° C.-1100° C. for 10-60 minutes.

22.-29. (canceled)

30. A lithium battery, comprising an anode, wherein the anode comprises a current collector and an anode material layer disposed on the current collector, wherein the anode material layer comprises the ternary material according to claim 1.
